(19) United States
(12) Patent Application Publication
(10) Pub. No.: US 2008/0202992 A1
(43) Pub. Date: Aug. 28, 2008

(54) PURIFIER INSERT WITH A TABLET DISPENSER AND INDICATOR

(75) Inventors: Michael A. Bridges, Seattle, WA (US); Bruce K. Bridges, Cardiff by the Sea, CA (US); Stephen Himley, Mill Creek, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: HALOSOURCE, INC., Bothell, WA (US)

(21) Appl. No.: 11/828,280

(22) Filed: Jul. 25, 2007

Related U.S. Application Data
(60) Provisional application No. 60/903,618, filed on Feb. 26, 2007.

(51) Int. Cl. B01D 35/143

(52) U.S. Cl. 210/85

(57) ABSTRACT

A water purifier that can be placed between an upper canister and a lower canister. The upper canister may include filters. Unfiltered water placed in the upper canister drains by gravity through the filters and water purifier into the lower canister. The water purifier includes a dispenser, a purifying media, and an indicator. Filtered, but unpurified, water passes from the upper canister into the water purifier, which houses the dispenser in which a material containing a chlorine and/or bromine compound is located. As water contacts the material, halogen is eluted to the filtered water. The purifying media contacts the unpurified water with halogen. The purifying media binds with the halogen, thereby maintaining the activity of the purifying media to purify the unpurified water. The water purifier may include an indicator to indicate when the material needs replacing.

### CROSS-REFERENCE TO RELATED APPLICATION

This application claims the benefit of U.S. Provisional Application No. 60/903,618, filed on Feb. 26, 2007, expressly incorporated in its entirety by reference herein.

### FIELD OF THE INVENTION

This application is related to water purification systems, including systems employing polymers having pendant heterocyclic N-halo amine groups, such as polystyrene having pendant N-halo hydantoin groups, and to apparatus employing such compounds.

### BACKGROUND OF THE INVENTION

Water purification systems are known that have an upper canister, a lower canister, and a filter. Generally, the filter is positioned between the upper canister and the lower canister so that water can flow by gravity from the upper canister through the filter and then enter the lower canister. A separation wall is provided to prevent the mixing of unfiltered water in the upper canister with filtered water in the lower canister. The filter can include activated carbon, iodinated resins, and the like. Water passing through the filter is collected in the lower canister, from which a user may remove filtered water for drinking.

A new class of purifying medium, referred to in the literature as “N-halamines,” have been found to be particularly useful in disinfecting water. N-halamine groups that are attached to a polystyrene polymer are described in U.S. Pat. No. 5,490,983. A crosslinked polystyrene polymer having similar pendant N-halamine groups is described in U.S. Pat. No. 6,548,054. The crosslinked polystyrene polymer is typically provided as beads. U.S. Pat. No. 7,014,781 describes a composition and method for sustaining the biocidal activity of the polystyrene-based polymers described in both of the above-mentioned patents.

Despite the teachings of the patents above, a need exists for producing water purification systems that are more efficient and less costly to operate, especially for a majority of the world's population who live in developing countries, who do not have municipal potable water facilities, and who must rely on either boiling water or other methods to achieve safe drinking water.

### SUMMARY

Embodiments of the present invention are related to water purifiers. Specifically, a water purifier is described that can be placed between an upper canister and a lower canister of an existing device. The upper canister may include filters, such as ceramic candle filters, or other filters. Unfiltered water placed in the upper canister drains by gravity through the filter into the lower canister. Embodiments of the water purifier, in accordance with the invention, can be placed between the upper and the lower canisters. The water purifier includes a dispenser, a purifying media, and an indicator. Filtered, but unpurified water passes from the upper canister into the water purifier, which houses the dispenser in which a material containing a chlorine and/or bromine compound is located. As water passes in contact with the material, the material elutes halogen to the filtered water, thereby producing unpurified water with halogen. The purifying media is placed in the path of the unpurified water with halogen. The purifying media binds with the halogen, thereby maintaining the biocidal activity of the purifying media to purify the unpurified water. The water purifier may also include an indicator that monitors the material to indicate when the material needs replacing.

An advantage of one embodiment of the invention is that the purifying media, such as one containing an N-halamine, can be maintained continuously biocidal by the introduction of a low level of chlorine and/or bromine in the unpurified water. The level of chlorine and/or bromine needed to maintain the biocidal activity of the purifying media is so low as to not provide an unpleasant taste or smell in the purified water. The treated water is suitable to be used for drinking.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a diagrammatical illustration of a system for purifying water using a purifier insert between an upper and a lower canister (shown in phantom) in accordance with one embodiment of the present invention;

FIGS. 2 and 3 are diagrammatical illustrations of exploded views of a purifier insert in accordance with one embodiment of the present invention;

FIG. 4 is a diagrammatical cross-sectional illustration of the purifier insert of FIGS. 2 and 3 in accordance with one embodiment of the present invention;

FIG. 5 is a diagrammatical illustration of a dwell chamber for the purifier insert of FIGS. 2 and 3 in accordance with one embodiment of the present invention;

FIG. 6 is a diagrammatical cross-sectional illustration of a purifier insert in accordance with one embodiment of the present invention;

FIGS. 7 and 8 are diagrammatical illustrations of exploded views of the purifier insert of FIG. 6;

FIG. 9 is a diagrammatical illustration of a quarter-sectional view of one embodiment of a water purifier;

FIG. 10 is a diagrammatical illustration of an exploded view of the water purifier of FIG. 9;

FIG. 11 is a diagrammatical illustration of a cross-sectional view of the water purifier of FIG. 9; and

FIG. 12 is a diagrammatical illustration of a close-up cross-sectional view of a portion of the water purifier of FIG. 9

### DETAILED DESCRIPTION

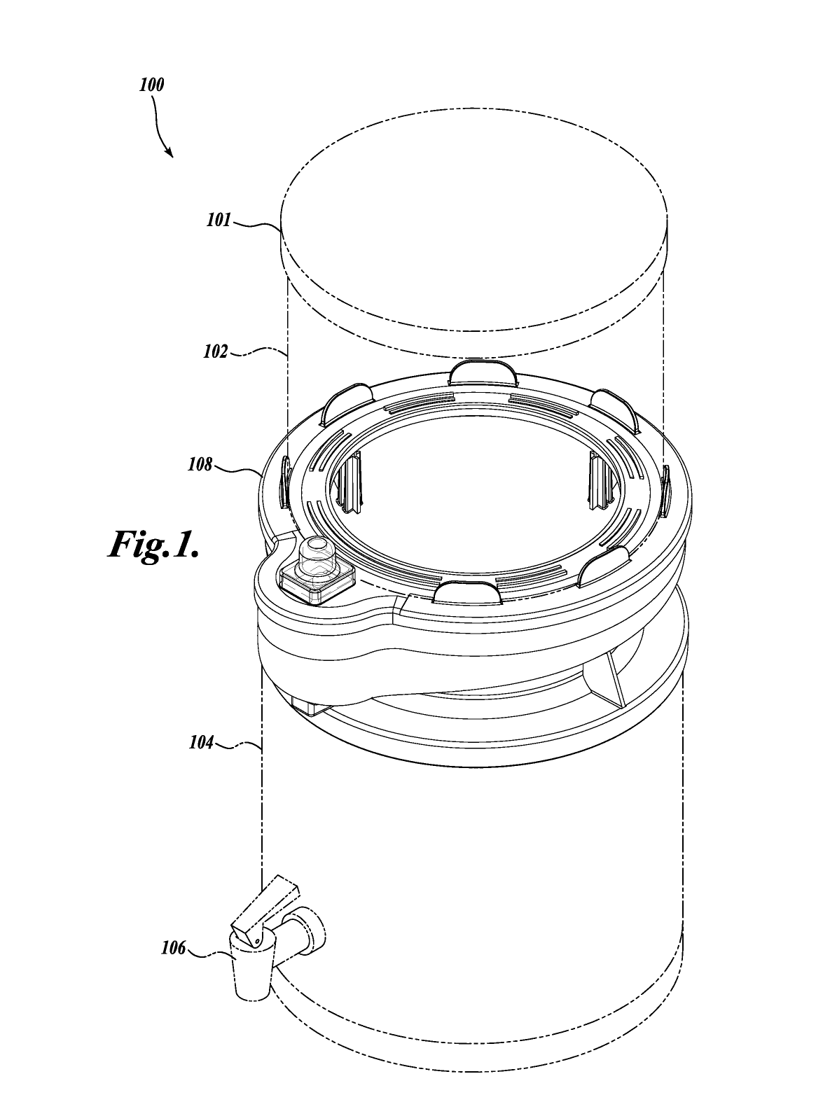

Referring to FIG. 1, a water purification system 100 is illustrated that includes a purifier insert 108 in accordance with one embodiment of the present invention. The dotted lines represent an upper canister 102 and a lower canister 104 of a typical gravity water purification system for home use. Water flows from the upper canister 102 into the lower canister 104 by gravity during which the water passes through some type of filter to filter the water. The filters may include ceramic candle filters in any number from one to four or more. The upper canister 102 is a cylinder with an open top. The upper canister 102 includes a lid or cover 101 for allowing the addition of unpurified water. Water poured into the top of the upper canister 102 flows through the ceramic filters into the lower canister 104. The lower canister 104 is a cylinder with an open top and a closed bottom. Filtered water is provided in the lower canister 104 that may be dispensed with a spigot 106. The upper canister 102 is generally separable from the lower canister 104 so that the system may be disassembled for cleaning.

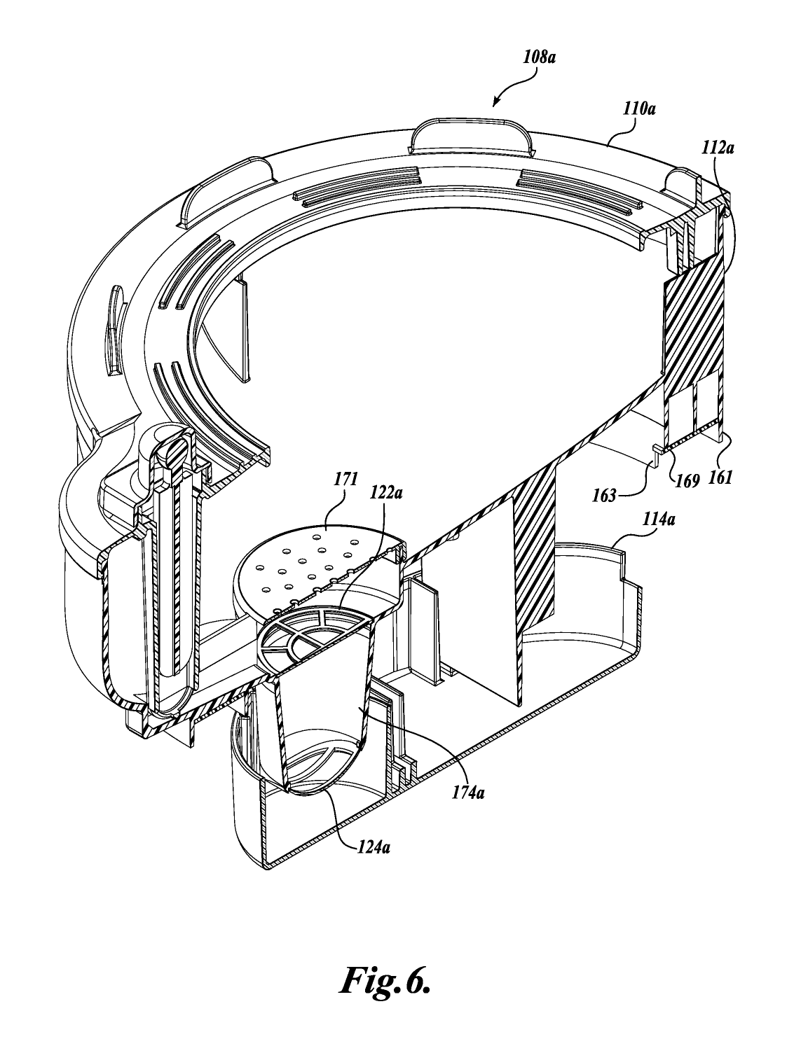

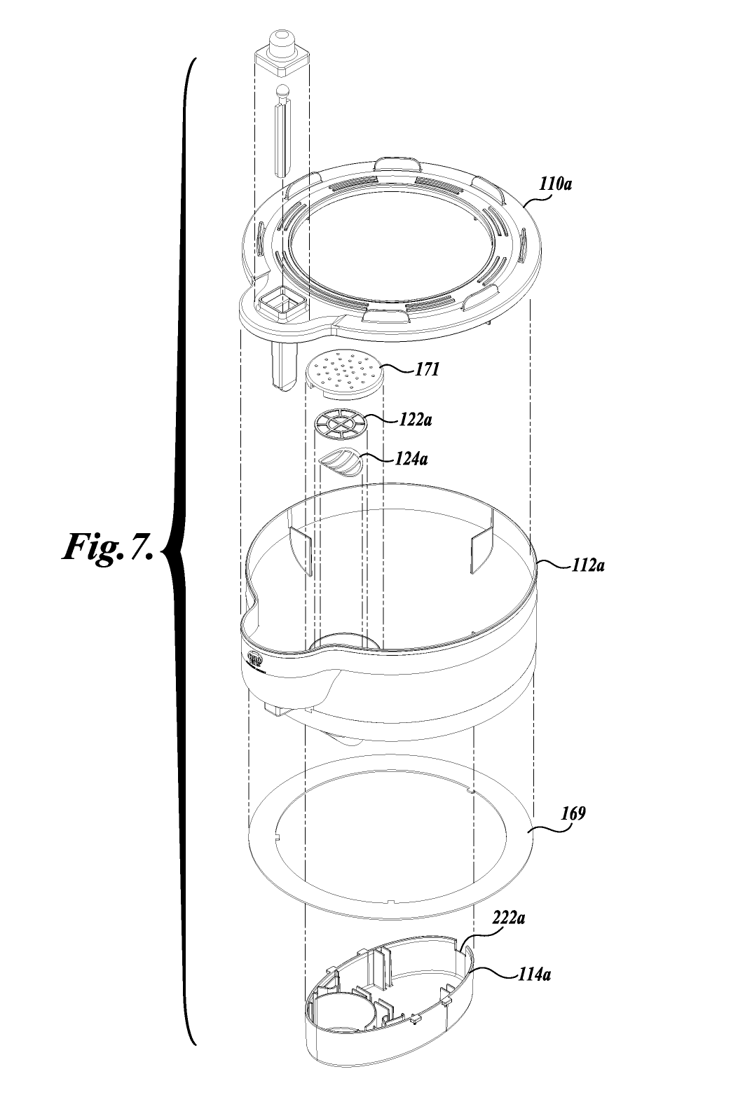

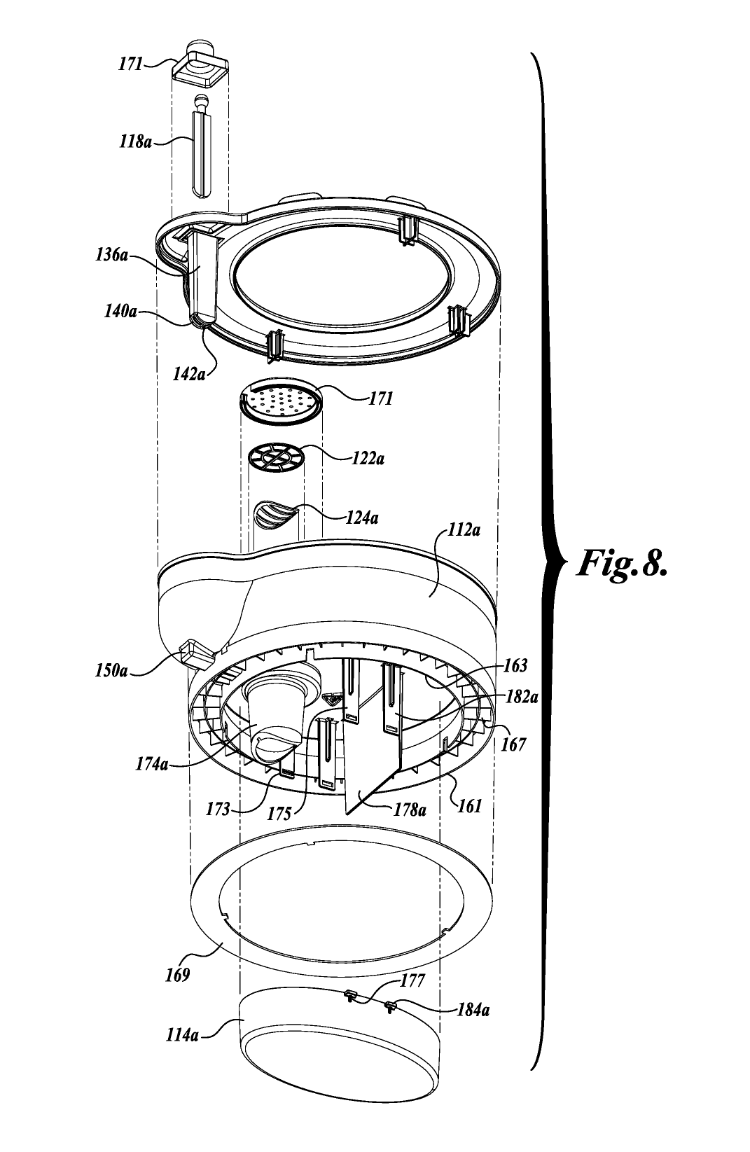

In accordance with one of the embodiments of the present invention, a purifier insert 108 is advantageously made to be positioned between the upper canister 102 and the lower canister 104 to additionally provide for purification and/or disinfection of the water. A second embodiment of a purifier insert 108a, described below and illustrated in FIGS. 6-8, may also be positioned between the upper canister 102 and the lower canister 104. The purifier insert 108 includes a purifying media including one or more N-halamines. A suitable purifying media for use in the purifier insert 108 is described in U.S. Pat. Nos. 5,490,983 and 6,548,058. An advantage of the purifying media is the ability to maintain biocidal activity by binding with halogen atoms present in the water passing in contact with the purifying media as described in U.S. Pat. No. 7,014,781, expressly incorporated herein in its entirety by reference. However, an efficient means of delivering halogen atoms to the purifying media is not described. In view of this, the purifier insert 108 includes a dispenser for dispensing a small dose of chlorine and/or bromine from a material to maintain the biocidal activity of the purifying media. The purifier insert 108 also includes an indicator that indicates when the material has been exhausted and/or needs replacement for user convenience and as an added safeguard.

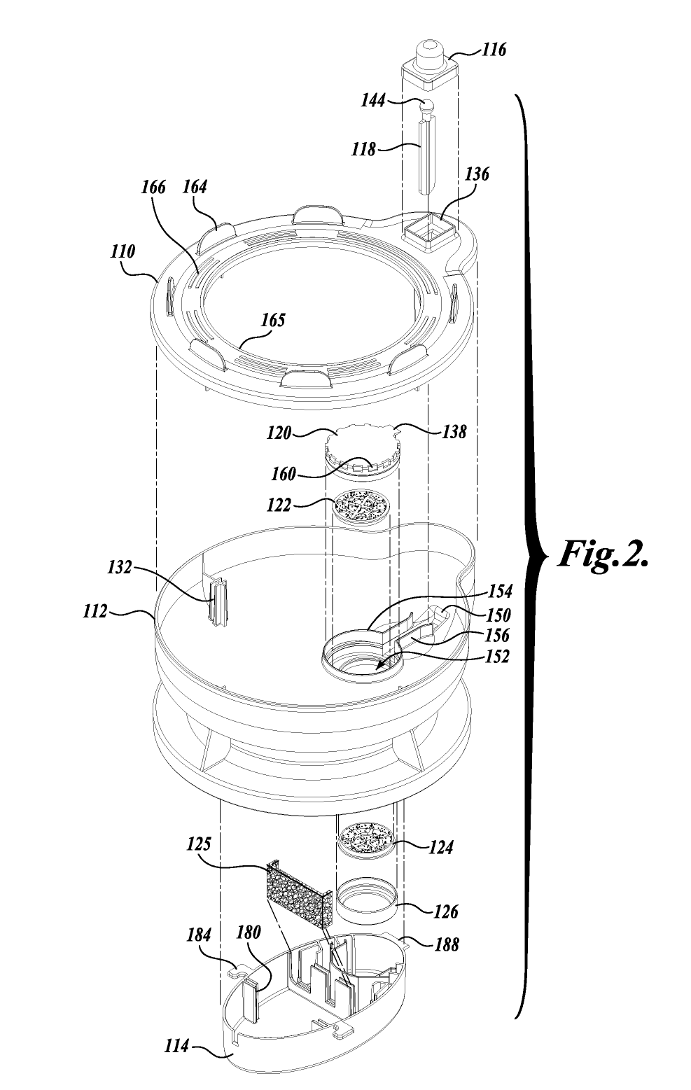

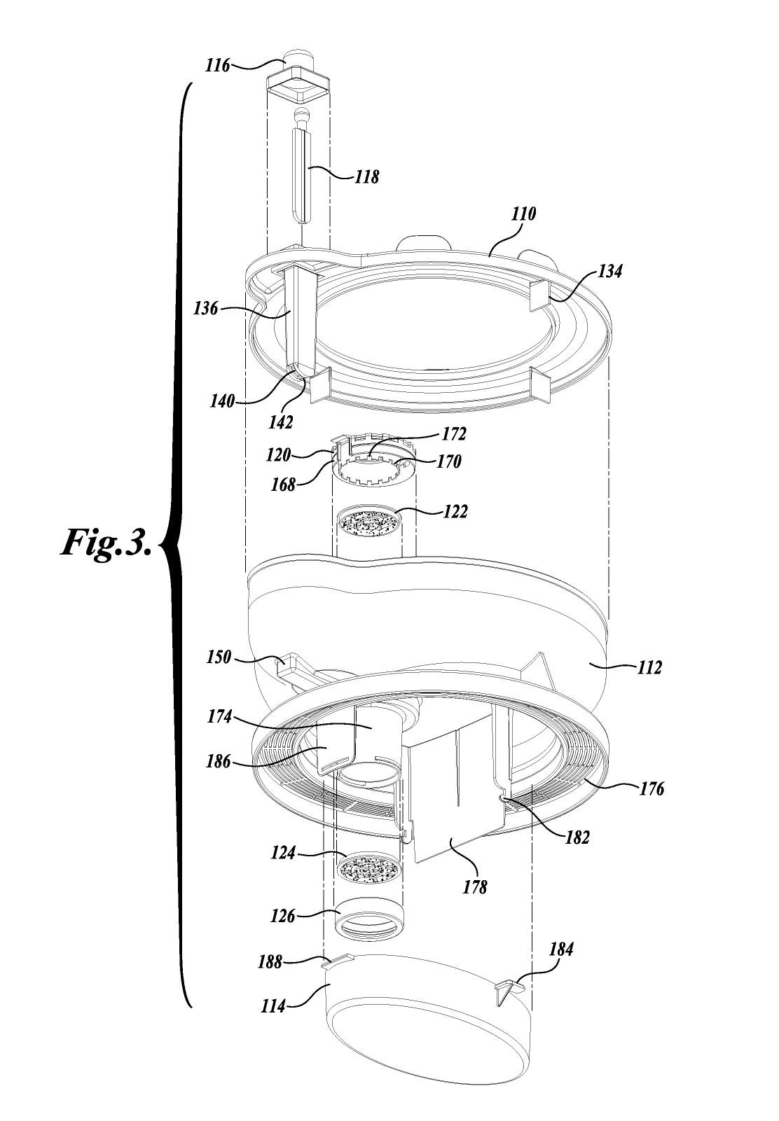

Referring to FIGS. 2 and 3, the purifier insert 108 in accordance with one embodiment of the present invention will be described.

The purifier insert 108 includes a top ring 110, a collection basin 112 disposed beneath the top ring 110 and suitably configured to be attached removably to the top ring 110 or, alternatively, it may be bonded to or integral with the top ring 110. The purifier insert 108 includes a dwell chamber 114 secured to the bottom of the collection basin 112. The purifier insert 108 includes a dispenser 136 incorporating an indicating rod 118 having an indicating flag 144 and a removable translucent cap 116 for viewing the indicating flag 144.

The top ring 110 has an upper and a lower surface, as seen in FIGS. 2 and 3, respectively. The upper surface of the top ring 110 is made to support the top canister 102. The upper surface of the top ring 110 may slope from a higher elevation at the inner diameter of the top ring 110 to a lower elevation at the outer diameter of the top ring 110 to prevent unfiltered water from bypassing the ceramic candle filters and entering the collection basin 112. The upper surface of the top ring 110 includes discrete locating features 164 spaced evenly around the circumference of the top ring 110 and perpendicular to the top surface of the top ring 110. The locating features 164 assist in locating the top canister 102 and prevent the top canister 102 from inadvertently being tipped or moved accidentally out of position. The upper surface of the top ring 110 also includes arcuate ribs 166 that are also evenly spaced around the circumference of the top ring 110. A plurality of arcuate ribs 166 arranged around the circumference of the top ring 110 defines a diameter of a certain size. Several diameters of pluralities of arcuate ribs 166 are provided to accommodate top canisters 102 of varying diameters. The upper surface of the top ring 110 may also include a continuous rib 165 at the inner diameter of the top ring 110. Additionally, the upper surface of the top ring 110 may have a sealing surface, such as rubber, so as to prevent water leakage between the bottom of the top canister 102 and the upper surface of the top ring 110. The top ring 110 includes an outward bulge to accommodate the dispenser 136.

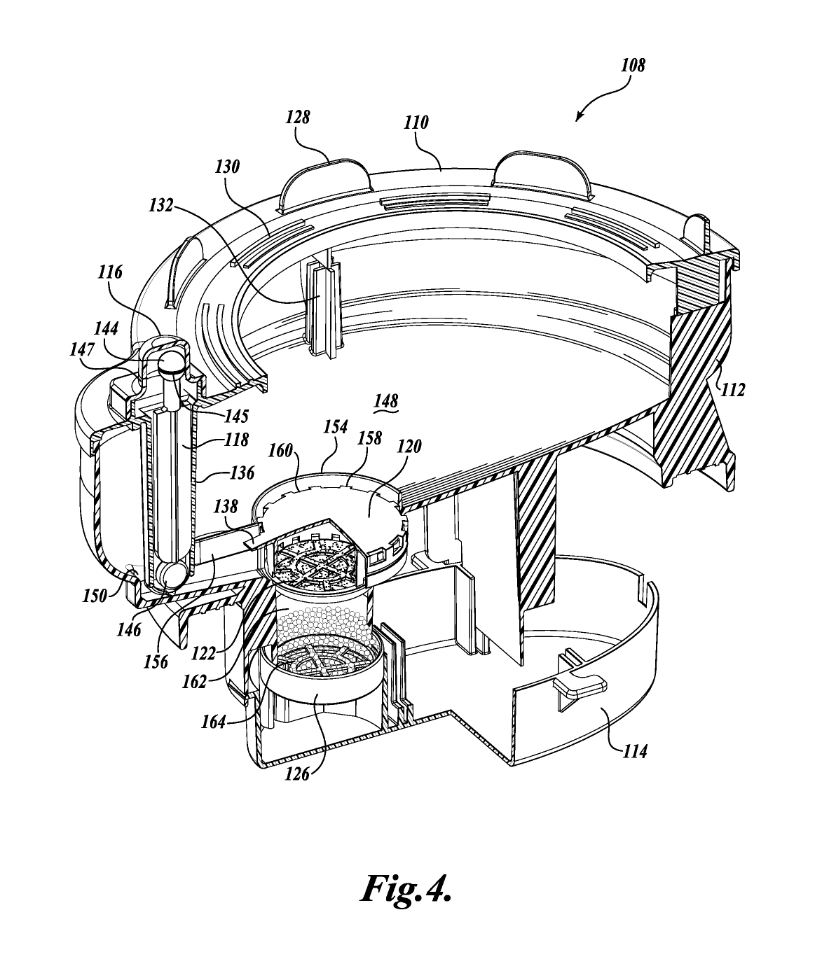

The dispenser 136 and a material 146 (best seen in FIG. 4) within the dispenser 136 that includes a source for halogen is one embodiment of a means for dispensing halogen to the unpurified water. The dispenser 136 includes a top opening that is accessible from the outside for placing the material 146 into the opening. The dispenser's 136 opening and the cross-sectional shape of the bore throughout the height of the dispenser 136 can match the profile of the material 146 to prevent the material 146 from assuming an inefficient position. Preferably, the material 146 remains vertical in the dispenser 136 as seen in FIG. 4. The dispenser 136 extends from the top surface of the top ring 110 (FIG. 2) through the top ring 110, and further extends below the top ring 110 (FIG. 3). The dispenser 136 terminates in an arcuate-shape end to match the shape of the material 146, and the end has forward 140 and rear 142 passages that permit water to enter the forward passage 140 and exit the rear passage 142. The opening of the dispenser 136 may be closed with a removable and replaceable cap 116. The cap 116 may be made entirely, or only selectively in places, from a transparent or translucent material to allow viewing into the interior of the cap 116.

The indicating rod 118 fits within the dispenser 136. The indicating rod 118 slides within the bore of the dispenser 136. The indicating rod 118 may have longitudinal ribs to prevent warping of the indicating rod 118 through continuous use. The indicating rod 118 is one embodiment of a means for indicating when the material 146 has been exhausted and/or needs replacing. The indicating rod 118 includes a visual mark or indicating flag 144 located at the top of the indicating rod 118, a portion or all of which is visible through the cap 116. The operation of the indicating rod 118 within the dispenser 136 will be described in further detail below.

The lower surface of the top ring 110 includes pegs 134 (as best seen in FIG. 3) that are generally spaced evenly along the circumference of the lower surface of the top ring 110. The pegs 134 are disposed perpendicular to the lower surface of the top ring 110. As can be appreciated from viewing FIGS. 2 and 3 collectively, the pegs 134 on the lower surface of the top ring 110 will mate with corresponding stands 132 on the upper surface or floor of the collection basin 112.

The collection basin 112 includes a concave floor that is bounded on all sides by a wall. The floor is punctuated by a hole 152 at or near to the deepest part of the concave floor to allow water to drain to and pool around the hole 152. The hole 152 leads into a purifying vessel 174 that will be described below. The hole 152 is surrounded by a barrier which includes a circular barrier 154 standing upright and around a majority of the hole 152. The barrier extends along a narrow channel 150 created in the floor of the collection basin 112 that extends deeper than the rest of the floor of the collection basin 112, as seen in FIG. 3. The narrow channel 150 is bordered by two oppositely positioned barrier walls 156. The barrier walls 156 are continuations of the circular barrier 154 surrounding the hole 152 and have an outward flare terminating at the end of the narrow channel 150. The purpose of the circular barrier 154 and the barrier walls 156 is to direct a minimum amount of water that pools around the hole 152 to be directed toward the open distal end of the narrow channel 150 and then flow within and along the narrow channel 150 and into the hole 152. As can be perceived in FIG. 3, the lower end of the dispenser 136 will seat into one end of the narrow channel 150. Accordingly, water that is placed into the top canister 102 and, after passing through any filters, will enter the collection basin 112, and be directed by the barriers 154 and 156 into the entry to the narrow channel 150 where the water will contact the end of the dispenser 136. Once at the dispenser 136, the water will then pass into the forward passage 140 and exit from the rear passage 142 of the dispenser 136, thereby making contact with the material 146 within the bottom end of the dispenser 136.

The hole 152 includes a first diameter and a second diameter. The first diameter is larger than, and positioned above, the second diameter. The first, higher placed diameter accepts a water distributor 120. The second, smaller diameter accepts a retaining screen 122.

As best seen in FIG. 3, the underside of water distributor 120 includes an outer ring 168 and an inner ring 170 having a diameter smaller than the outer ring 168. Furthermore, the inner ring 170 is offset from the center of the water distributor 120, or the inner ring 170 is not concentric with the outer ring 168. The outer diameter of the outer ring 168 is made to fit within the higher, inner diameter of the hole 152, so that the top surface of the water distributor 120 is below the top edge of the barrier 154. The top surface of the water distributor 120 is best seen in FIG. 4. The top surface is solid to protect the purifying media 164 from being impacted by drops of water from the top canister 102. The water distributor 120 includes a series of notches 160 spaced evenly around the outer circumference or periphery of the top surface of the water distributor 120. The water distributor includes a tab 138. The tab 138 fits within the narrow channel 150 defined by the barriers 156. The tab 138 may come to rest with the bottom of the narrow channel 150 between the barrier walls 156. Thus, water that flows within the narrow channel 150 after exiting the rear passage 142 at the end of the dispenser 136 will flow over the top surface of the water distributor 120 and will be substantially evenly distributed and pass through the notches 160 into the interior of the outer ring 168, but on the exterior of the inner ring 170. Between the outer ring 168 and the inner ring 170, the water is again distributed through notches 172 made in the lower periphery of the inner ring 170. The second set of notches 172 further assist in even distribution of the water from the collection basin 112 into the hole 152.

A first top retaining screen 122 is positioned below the water distributor 120 in the second, smaller diameter of the hole 152. The top retaining screen 122 leads into the purifying vessel 174 (as best seen in FIG. 3). The purifying vessel 174 extends below and on the underside of the floor of the collection basin 112 to create a suitable volume for the purifying media 164. The purifying vessel's 174 width and height dimensions are preferably about the same (1 to 1) to minimize the probability of channeling while maximizing flow rate. The purifying vessel 174 contains the purifying media 164, such as a polymer with pendant N-halamine groups. The purifying media 164 preferably can come in the form of beads. A second and bottom retaining screen 124 is placed within the lower opening of the purifying vessel 174. The bottom retaining screen 124 is held in place by a retaining ring 126, which can snap fit or otherwise be secured to the bottom of the purifying vessel 174. The top screen 122 and the bottom screen 124 can include a flexible polypropylene mesh to trap about 99% or more of the beads. In one embodiment, the average size of the holes in the top mesh is about 300μ (microns) and about 150μ in the bottom mesh.

As best seen in FIG. 3, a lower surface of the collection basin 112 includes a series of labyrinth rings 176 defining a plurality of varying diameters that are interrupted by a gap at evenly spaced intervals. The labyrinth of locating rings 176 on the lower surface of the collection basin 112 allows the collection basin 112 to be used with lower canisters 104 of varying diameters. The labyrinth of rings 176 rests on top of the upper edge of the lower canister 104 and allows air to escape as water enters and fills the lower canister 104.

The underside of the floor of the collection basin 112 includes a dam 178 projecting perpendicularly from the underside of the floor. As can be appreciated from viewing FIGS. 2 and 3 collectively, the dam 178 will fit within and span across a first and second holder 180 of the dwell chamber 114. Further, a first and a second retaining snap hook 182 are provided on each lateral side of the dam 178. The retaining snap hooks 182 are joined to cooperating first and second retaining snap hooks 184 on the exterior lateral sides of the dwell chamber 114 (as best seen in FIG. 2). The function of the dam 178 will be described below in connection with the dwell chamber 114. The underside of the collection basin 112 further includes a snap tab 186 projecting downwardly and having a slot at the lower end thereof. The slot at the end of the snap tab 186 fits into the peg 188 at the exterior end of the dwell chamber 114 (FIG. 3). Thus, by the cooperating features of the peg 188 and snap tab 186, along with the retaining snap hooks 182 on the collection basin 112 and the retaining snap hooks 184 on the dwell chamber 114, the dwell chamber 114 is held securely to the bottom of the collection basin 112.

The upper 102 and lower 104 canisters of the water purification system 100 are conventional. The purifier insert 108 or 108a can be purchased separately. An advantage of one embodiment of a purifier insert 108 or 108a is that many of the existing water purification systems utilizing an upper 102 and a lower 104 canister can be refitted with the purifier insert 108 or 108a. Because of the features which will now be described, the overall cost for operating the purifier insert 108 or 108a will be low. The life of the purifier insert 108 or 108a is expected to depend on the life of the purifying media that is located within the purifying vessel 174 or 174a, respectively.

Referring to FIG. 4, the dispenser 136 accommodates the material 146, such as a tablet, including a chlorine and/or bromine containing compound that elutes chlorine and/or bromine to water. Such tablet 146 is described in PCT Publication No. WO 2005/033004 and PCT Publication No. WO 2006/105379, both incorporated herein expressly by reference. The composition of such material will not be described in detail herein for brevity. The composition being apparent from the publications of the aforementioned PCT applications. The end of the dispenser 136, as described before, fits within the narrow channel 150. Therefore, the tablet 146, being at the bottom end of the dispenser 136, also sits submerged within the narrow channel 150. The tablet 146 can be submerged below the floor of the collection basin 112 generally less than 1 inch. The dispenser 136 sits at the end of the narrow channel 150 opposite from the water distributor 120. As water enters the collection basin 112, water pools toward and around the barriers 154 and 156 that direct the water toward the rear of the narrow channel 150 where the end of the dispenser 136 is located. The barriers 154 and 156 can, at least, direct a low and generally constant rate of flow of water into the narrow channel 150. This feature enables the tablet's 146 elution rate of chlorine and/or bromine to be relatively constant regardless of very low flow or very high flow coming from the upper canister 102. It is to be appreciated that water can also flow over, on top of, or around the barriers 154 and 156 to bypass the dispenser 136. However, bypassing of the dispenser 136 does not affect the operability of the purifying media 164 because the purifier insert 108 is designed to provide a minimum amount of flow to the dispenser 136 that results in continuously maintaining the biocidal activity of the purifying media 164. The purifier insert 108 is designed to operate with upper canisters 102 that may provide flows of about 20 ml/min to about 300 ml/min and still deliver a low and relatively constant flow to the dispenser 136. Generally, the time that the tablet 146 is immersed is about 120 minutes to about 200 minutes for flow rates of about 20 ml/min (corresponds to about 150 minutes) to about 270 ml/min (corresponds to about 135 minutes). Unpurified water from the upper canister enters into the narrow channel 150 at about the location at the end of the dispenser 136. Thereafter, the water passes into the forward passage 140 in the dispenser 136. The water which enters the dispenser 136 makes contact with the tablet 146, whereby the tablet 146 releases halogen to the water, thus, in the process, also consuming the tablet 146. The unpurified, but halogen-containing water now exits the dispenser 136 from the rear passage 142, but still within the narrow channel 150. Thereafter, the unpurified, but halogen-containing water passes to the water distributor 120, either on the top surface of the water distributor 120, or around the outer periphery of the water distributor 120 (a seal is not necessary). Thereafter, the water passes through the retaining screen 122 and into the purifying vessel 174.

An indicating means 118 for indicating when the tablet 146 has been exhausted, consumed, and/or when the tablet 146 needs replacing will now be described with reference to FIG. 4. The tablet 146 rests at the bottom end of the interior of the dispenser 136. The indicating rod 118 comes to rest on top of the tablet 146. The indicating rod 118 includes a spherical indicating flag 144 at the upper end thereof. The spherical shape can achieve a faster apparent drop rate as the tablet 146 dissolves. The dispenser's 136 opening is accessible from the top surface of the top ring 110 so that a cap 116 can be removably and replaceably placed over the dispenser 136 opening. All or a selected portion of the cap 116 may be made of a transparent or translucent material to allow viewing the indicating flag 144. In one embodiment, the indicating flag 144 may have a narrow, high contrast band 145, while the remainder of the indicating flag 144 can be a dull color which allows the band 145 to stand out and be readily distinguishable. Many other variations would be apparent from the description herein. In one embodiment, the cap 116 can be opaque except for a narrow horizontal window 147. Accordingly, when the tablet 146 is completely intact, the narrow band 145 is above the window 147 and is not visible through the window 147. As water begins to wear down or consume the tablet 146, the indicating rod 118 correspondingly drops, thus lowering the height of the band 145. At a predetermined height, when the tablet 146 is nearing total exhaustion or needing replacing, the indicating rod 118 will have fallen a sufficient amount so that the indicating band 145 will be visible through the window 147. Thus, an indication is provided to the user to remove the cap 116 and the indicating rod 118, and to add a new tablet 146 into the dispenser 136. Thereafter, the indicating rod 118 is replaced, along with the cap 116, and the purifier insert 108 can be put to use again. Via this method, the purifying media 164 is continuously maintained biocidally active. Accordingly, once the initial investment is made to purchase the purifier insert 108, the only expense in operation of the purifier insert 108 is the purchase of the tablets 146. As an alternative, the cap 116 can have a scale with calibrated markings that indicate the percentage of the tablet 146 remaining in the dispenser 136. For example, when a new tablet 146 is placed in the dispenser 136, the band 145 can correspond with a line on the cap 116 indicating 100%. As the tablet 146 is consumed, the band 145 will correspondingly drop. Markings on the cap 116 can indicate, for example, 75%, 50%, 25%, and 0%. The indicating flag 144 can also be various colors, such as green, yellow, and red, to indicate status of the tablet 146. Alternatively, the indicating flag 144 can be completely visible so long as the tablet 146 does not need replacing. However, when the tablet 146 has been exhausted or needs replacing, the indicating flag 144 will no longer be visible. A further alternative is to make the dispenser 136 and that portion of the collection basin 112 in which the dispenser 136 sits transparent so that direct observations of the tablet 146 can be made. Another alternative is to eliminate the dispenser 136 entirely so that the tablet 146 sits in a compartment in the narrow channel 150.

In the purifying vessel 174, the unpurified water carrying the small dose of chlorine and/or bromine (and with or without any water that bypasses the dispenser 136) makes contact with the purifying media 164. The percentages of chlorine and/or bromine in the unpurified water are described in the aforementioned PCT publications, but generally range from 0.1 ppm to 10 ppm, and more particularly from about 0.1 ppm to about 3 ppm for chlorine, and from about 0.2 ppm to about 4 ppm for bromine. Several embodiments of the purifying media 164 are described in U.S. Pat. No. 5,490,983 and U.S. Pat. No. 6,548,054, both incorporated herein expressly by reference. The purifying media 164 includes, but is not limited to, compounds selected from a heterocyclic N-halo amine, an N-halo hydantoin, a polystyrene having pendent N-halo hydantoin groups, or a crosslinked polystyrene having pendent N-halo hydantoin groups. Representative chemical formula of the purifying media 164 includes, but is not limited to, the following Structure (I) or Structure (II):

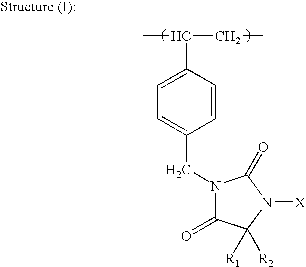

wherein R₁ and R₂ are independently selected from C₁-C₄ alkyl, phenyl, and aryl, and X is chlorine or bromine.

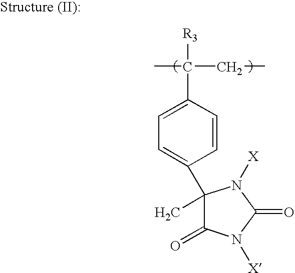

wherein X and X′ are independently chlorine, bromine, or hydrogen, provided that at least one of X or X′ is chlorine or bromine; and R₃ is hydrogen or methyl.

The polystyrene polymer of either Structure (I) or Structure (II) may be crosslinked with a crosslinking agent, such as divinylbenzene, to provide the purifying media 164 in a sufficient particle size range so as not to be lost through the retaining screens 122 and 124. The crosslinking agent can be present in an amount from about 3% to about 10% by weight of the total weight of polymer. Typically, the polystyrene will be crosslinked before the hydantoin group is attached. One embodiment of the purifying media 164 is a 3% to 10% crosslinked Structure (II), wherein X is bromine and X′ is hydrogen.

The halogen (X) of Structure (I) and (X or X′) of Structure (II) is continuously used up and replaced with new halogen from the unpurified water, which has made contact with the tablet 146. Contact between the unpurified, but halogen-containing water with the purifying media 164 causes the halogen from the water to be transferred to the media 164 to any one or both positions X and X′ to maintain the biocidal activity of the purifying media 164, and also resulting in killing bacteria and/or other microorganisms in the water, thus purifying the water. The performance of the purifying media 164 to purify the water may be expressed as a log reduction according to the microorganism. For example, the United States Environmental Protection Agency's (USEPA) Guide Standard for Water Purifiers is currently defined as a 3 log reduction in cryptosporidium, a 6 log reduction in klebsiella terrigena, or a 4 log reduction in a combined poliovirus/rotavirus challenge. As used herein, “purify” means to achieve a level of microorganisms that provides water generally considered adequate for human consumption. The purified water that may have residual amounts of chlorine and/or bromine will exit the purifying vessel 174, pass through the second, lower retaining screen 124 where it will next enter the dwell chamber 114.

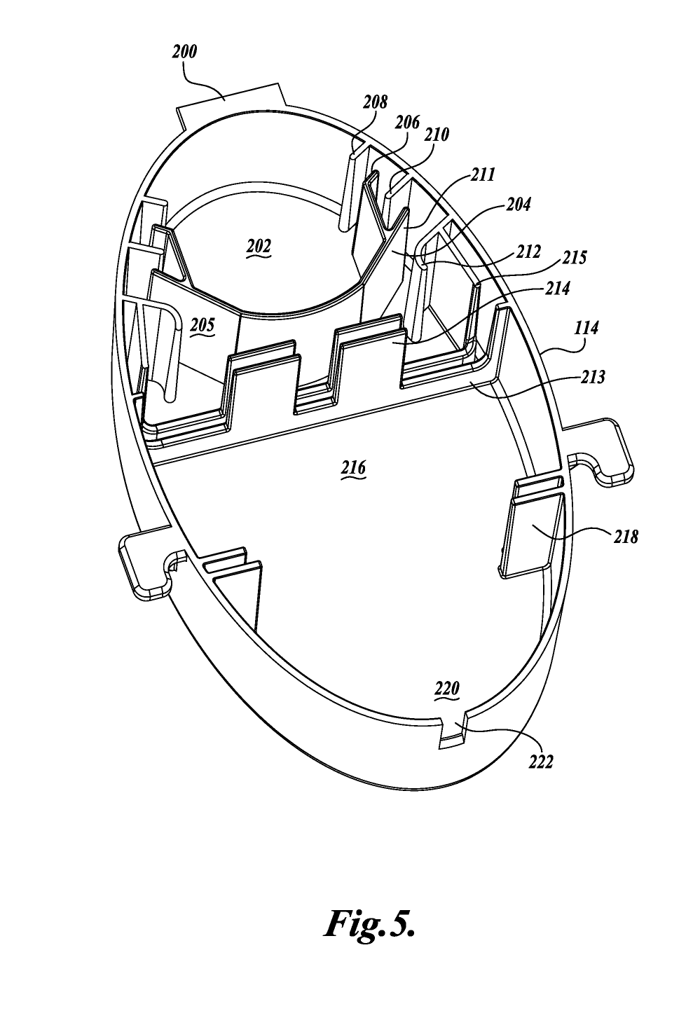

As best seen in FIG. 5, the dwell chamber 114 includes a compartment 202 for receiving the lower end of the purifying vessel 174. The bottom end of the purifying vessel 174 sits above the water level in the dwell chamber 114.

The compartment 202 for accepting the lower end of the purifying vessel 174 is defined by a front barrier 204 and the distal end of the dwell chamber 114. The front barrier 204 directs the water through a series of baffles causing the water to change direction various times. The baffles cause the water flow to proceed evenly through the dwell chamber 114. For example, once the water enters the compartment 202, the front barrier 204 directs the water to flow between a distal baffle 208 extending from the inner side of the dwell chamber 114 and a proximal baffle 206 extending from the front barrier 204. Therefrom, the water is again redirected by a baffle 210 extending from the inner side of the dwell chamber 114 that is proximal to the baffle 206. The water is again redirected by a baffle 211 that is proximal to the baffle 210. The baffle 211 is also an extension of the front barrier 204. The water now leaves the compartment 202 and series of baffles through a curved funnel 212, and enters a prefilter compartment 205. The prefilter compartment 205 is separated from a post-filter compartment 216 by a filter holder 214 having two larger lateral openings and one smaller central opening. A felt filter 125 (best seen in FIG. 2) is provided in the holder 214 within two receiving vertical guides 214 lateral to the central opening, a bottom linear guide 213, and two side guides 215, one on each side of the dwell chamber 114. The vertical guides 214 and the side guides 215 keep the felt filter 125 in place, and the bottom linear guide prevents water from flowing underneath the felt filter 125. The felt filter 125 sits within the linear guide 213 and the two vertical guides 214 and the ends of the felt filter 125 curve around and between the side guides 215 and the inner wall of the dwell chamber 114. The felt filter 125 height is lower than the openings in the holder 214 and the side walls of the dwell chamber 114, so that were the felt filter 125 to plug, the water would flow up and over the felt filter 125 and remain in the dwell chamber 114. The purpose for this is so that the water stays in dwell chamber 114 for the adequate amount of time instead of the water pouring over the sides of the dwell chamber 114. The felt filter 125 traps particulates, such as the beads of the purifying media 164, which may escape from the purifying vessel 174. The size of openings in the felt filter 125 can trap particulates of about 5μ (microns). The felt filter 125 divides the prefilter compartment 205 from the post-filter compartment 216. The holder 214 includes three areas for passage from the prefilter compartment 205 to the post-filter compartment 216. A narrow window is provided in the center, while two larger windows are provided at each lateral side. After the felt filter 125, the water passes into the post-filter compartment 216. A dam 178 separates the post-filter compartment 216 from a pre-discharge compartment 220.

As can be appreciated from FIG. 3, the water passes below the dam 178. The dam 178 rests between two lateral guides. The lateral guides prevent streamlined flow past the sides of the dam 178. The dam's 178 bottom edge is raised above the floor of the dwell chamber to increase the path that the water travels. The series of baffles 208, 206, 210, 211, and 212, along with the felt filter 125 and the dam 178, are intended to even the flow of water, prevent turbulence, provide a dwell time of about 60 seconds, and avoid any premature discharge of the water. Dwell time in the compartments 202, 205, 216, and 220 is included for additional purification to occur.

Once past the dam 178, the water enters the pre-discharge compartment 220, where as the water begins to rise, the water will be discharged through a notch 222 made in the wall of the dwell chamber 114. The notch 222 height is higher than the bottom of the purifying vessel 174 to maintain the level of water in the dwell chamber 114 higher than the bottom end of the purifying vessel 174. From the notch 222, the purified water will leave the purifier insert 108 and collect in the lower canister 104, as best seen in FIG. 1. The user may dispense the purified water from the spigot 106.

Referring to FIGS. 6, 7, and 8, a second embodiment of a water purifier insert 108a that includes a dispenser to deliver halogen from a material to unpurified water thereby producing unpurified water with halogen; a purifying media in the path of the unpurified water with halogen, wherein the purifying media binds the halogen thereby maintaining the biocidal activity of the purifying media to purify the unpurified water into purified water; and an indicator that monitors the material to indicate when the material needs replacing is illustrated.

The embodiment illustrated in FIGS. 6, 7, and 8 is in many respects similar to the embodiment illustrated in FIGS. 1-5. For the sake of brevity, the differences between the first and second embodiments are described. However, it is understood that features described in relation to the embodiment of FIGS. 1-5 may be included in the embodiment of FIGS. 6-8.

The first embodiment includes a series of labyrinth rings 176 on the underside of the collection basin 112; however, the embodiment of FIGS. 6-8 includes discrete ribs 165 extending radially between two concentric and downwardly projecting rims 161, 163 from the underside of the collection basin 112a. The lower edge of each rib 167 is shorter than the height of the concentric rims 161, 163. A seat 169 is placed between the inner perimeter of the outside rim 161 and the outer perimeter of the inside rim 163 so that the upper surface of the seat is in contact with the lower ends of the ribs 167. The seat 169 is, therefore, made to contact the upper edge of a lower canister. The seat 169 distributes weight evenly between the collection basin 112a and the lower canister. The seat 169 also prevents insects from making nests in the spaces formed by the ribs 167, but is sized to allow a minimum of air venting from the lower canister to the outside as water enters the lower canister.

In place of the water distributor 120 of the first embodiment, the embodiment illustrated in FIGS. 6-8 includes a cap 171 disposed over the open upper end of the purifying vessel 174a. The cap 171 includes small perforations on the upper surface extending through the thickness of the cap 171. The upper surface of the cap 171 is at least as high as the height of the sidewall barriers 156a and circular barrier 154a. The circular cap 171 can be positioned so that it comes to rest on the top edge of the circular barrier 154. The purifying vessel 174a includes a top retaining screen 122a and a bottom retaining screen 124a. The bottom retaining screen 124a, unlike the first embodiment, is bowed downwardly from the end of the purifying vessel 174a, such that the bottom screen 124a may be in contact with and submerged in the water in the dwell chamber 114a. The downward bow feature allows air bubbles to migrate up and away from the center of the purifying vessel 174a, thus minimizing obstruction to water flow by trapped air bubbles. An alternative may be to increase the height of the purifying vessel 174a, and/or to increase the height of the slot 222a cut into the dwell chamber 114a to raise the water level in the dwell chamber 114a so that the purifying vessel 174a is partially submerged therein. A benefit of having the lower end of the purifying vessel submerged in the water in the dwell chamber 114a is to achieve greater microbiological killing efficacy by creating more uniform flow in the purifying vessel 174a. A further distinction between the embodiment of FIGS. 6-8 and the embodiment of FIGS. 1-5 is that the collection basin 112a has a substantially constant outer diameter from the top of the collection basin 112a below the top ring 110a to the lower rim 161. A skirt may be provided around the perimeter of the collection basin 112a toward this end to facilitate molding. A further distinction relates to providing a second pair of snap hooks 173, 175 projecting downwardly from the lower surface of the collection basin 112a and on lateral sides of the dam 178a to mate with snap hooks 177 on lateral sides of the dwell chamber 114a to assist in holding the dwell chamber 114a to the collection basin 112a.

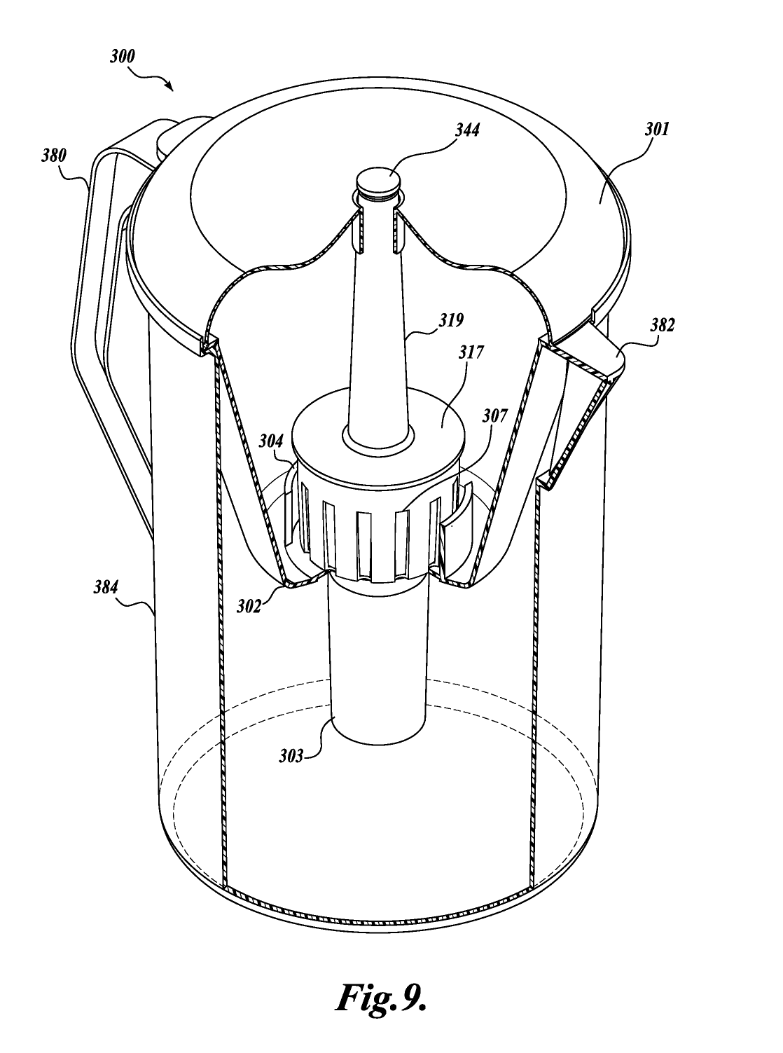

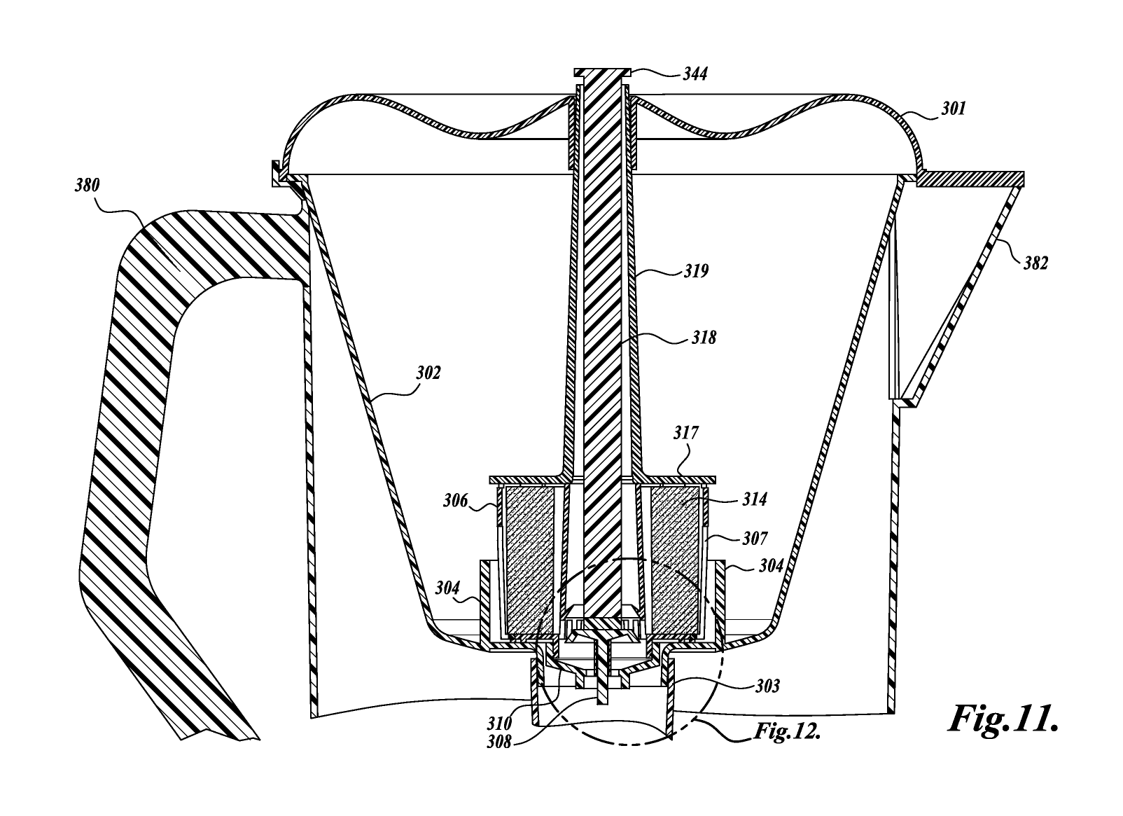

Referring to FIGS. 9-12, another embodiment of a water purifier including a dispenser to deliver halogen from a material to unpurified water thereby producing unpurified water with halogen; a purifying media in the path of the unpurified water with halogen, wherein the purifying media binds the halogen thereby maintaining the biocidal activity of the purifying media to purify the unpurified water to purified water; and an indicator that monitors the material to indicate when the material needs replacing is illustrated. The second embodiment is provided as a pitcher 300.

The pitcher 300 includes features, such as a handle 380 used to grasp the pitcher, a spout 382 from which water is poured, and a cylindrical body 384, which is used as a lower canister to receive purified water. The pitcher 300 includes a vertically elongated cylindrical body 384 having a closed bottom and an open top. The top opening of the pitcher 300 may be closed by a lid or cover 301. The cover 301 may snap fit onto the top open end of the pitcher 300. The circumference at the top portion of the pitcher 300 includes a lip. The lip supports an upper canister 302, which is used to receive the unpurified, unfiltered water. The cover 301 includes a central aperture. On the underside of the cover 301, the cover 301 includes a cylindrical neck extending vertically downward for a short distance from the central aperture. An end of an indicating rod guide 319 is inserted within the inside circumference of the neck. The indicating rod guide 319 has a tapered elongated cylindrical portion attached to a flat radially extending disk 317. The cylindrical tapered portion includes a bore through which an indicating rod 318 can slide within.

The upper canister 302 that is supported by the rim of the pitcher 300 includes a circular wall that is reduced in diameter from top to bottom. The top diameter of the upper canister 302 substantially matches the inner diameter of the pitcher 300, while the bottom diameter of the upper canister 302 is about one-third to one-fourth smaller than the top diameter. The bottom of the upper canister 302 extends down into the pitcher 300 about one-third of the height of the pitcher 300 to accommodate a purifying vessel 300 attached to the underside of the upper canister 302. The bottom of the upper canister 302 includes a floor, including a central aperture therethrough. Adjacent, but not immediately next to the aperture, arcuate barriers 304 extend upwards from the floor of the upper canister 302. A number of spaces or notches are formed between the ends of the barriers. An O-ring seal 312 sits at the bottom of the floor of the upper canister 302 outside of the aperture but within the arcuate barriers. The O-ring seal 312 may be made from a flexible material, such as rubber, or a flexible rubber-like material. The diameter of the O-ring seal 312 is greater than the aperture in the floor of the upper canister 302. A circular plunger guide 310 has an outer diameter that is about the same as the diameter of the central aperture in the floor of the upper canister 302. The plunger guide 310 fits within the aperture and is rigidly fixed thereto. The plunger guide 310 has a rim extending around the outer circumference of the plunger guide 310. The plunger guide 310 has a vertical neck projecting upwardly in the center thereof with a bore through the neck. The plunger guide 310 further includes apertures that pass through the center of the plunger guide 310 and next to the vertical neck. A plunger 308 has a mushroom head and a stem extending beneath the mushroom head. The stem fits within the bore in the vertical neck of the plunger guide 310 and can slide within the vertical neck of the plunger guide 310. The plunger 308 mushroom head has a flat top and sloping sides around the circumference of the mushroom head.

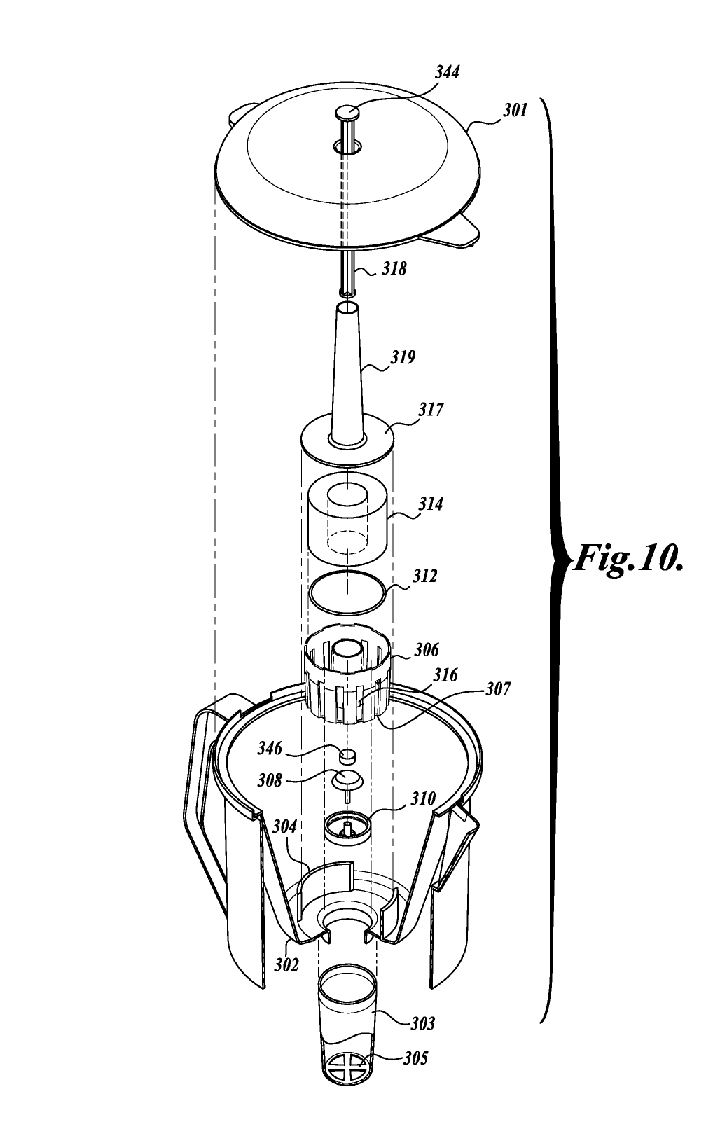

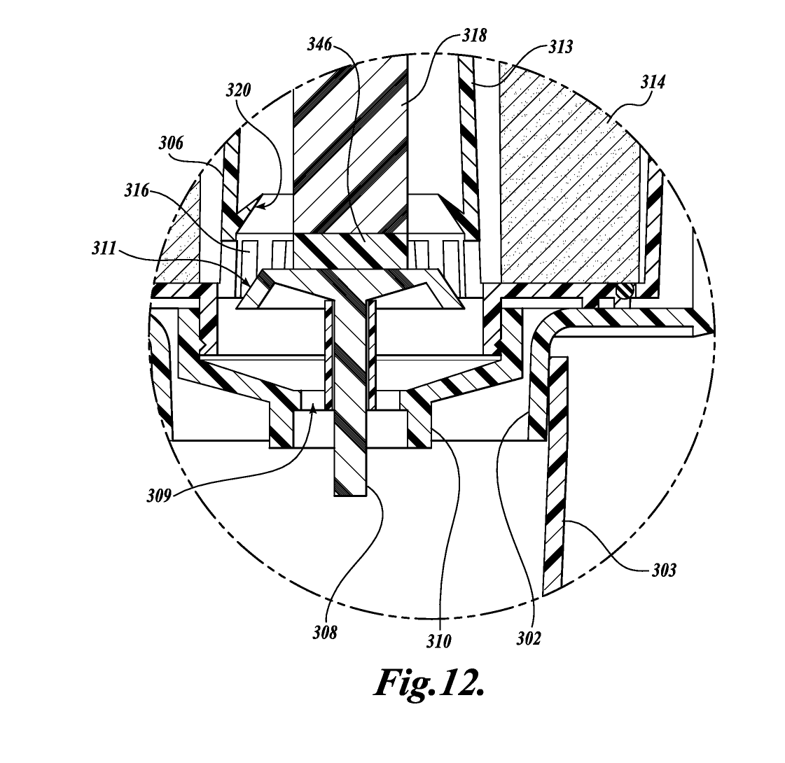

A filter case 306 is placed on the floor of the upper canister 302. The filter case 306 has a first outer cylindrical wall and a second inner cylindrical wall having a diameter smaller than the outer cylindrical wall. The filter case 306 is attached to the flat radially extending disk 317. A second disk at the bottom of the filter case 306 connects the outer wall to the inner wall. As will be described below, the inner cylindrical wall in combination with the indicating rod guide 319 acts as a dispenser similar to dispenser 136 of the previous embodiments. Vertical slits 307 are provided in the outer cylindrical wall that leads into the interior. The filter case 306 has a rim on the underside of the filter case 306 substantially the same diameter as the inner cylindrical wall. The outside surface of the rim on the underside of the filter case 306 is engaged to the inside surface of the rim of the plunger guide 310 (as best seen in FIG. 12). The underside of the filter case 306 further seals against the O-ring 312 to thus create a barrier against the passage of water underneath the filter case 306. Accordingly, all water poured into the upper canister 302 passes through the slits 307 in the outer cylindrical wall of the filter case 306. From the slits in the filter case 306, the water passes through a filter medium 314 placed between the outer cylindrical wall and the inner cylindrical wall. The filter medium 314 may include ceramic filters, activated carbon, or the like. The filter medium 314 has an outer diameter smaller than the inner diameter of the outer cylindrical wall of the filter case 306. The filter medium 314 has an inner diameter larger than the outer diameter of the inner cylindrical wall of the filter case 306. The top and bottom surfaces of the filter medium 314 are connected to the lower surface of the flat radially extending disk 317 and the inner surface of the bottom of filter case 306. Water entering the slits 307 in the filter case 306 then passes through the filter medium 314. After passing through the filter medium 314, the water is directed to holes 316 in the lower section of the inner cylindrical wall of the filter case 306 (best seen in FIG. 12). After exiting through the holes 316 at the bottom of the inner cylindrical wall, the water is then in an area to allow contact between the filtered, but unpurified water and a tablet 346 resting on the top surface of the mushroom head of the plunger 308. The tablet 346 makes contact with the bottom end of the indicating rod 318. The tablet 346 and the previously described tablet 146 may be made from similar materials and function in similar ways. Similar to tablet 146, the tablet 346 elutes chlorine and/or bromine to water coming in contact with the tablet 346. Thereafter, the water containing halogen atoms passes through the central holes in the plunger guide 310 and into the purifying vessel 303, which contains a purifying media, as described herein, so that the water containing halogen makes contact with the purifying media. As best seen in FIG. 10, the purifying vessel 303 includes an elongated, generally cylindrical body having an open end at the top and a retaining screen 305 at the bottom. The purifying vessel 303 holds the purifying media similar to what has been described above. The purifying vessel 303 is bonded to a rim extending downwardly from the underside of the upper canister 302. Similar to the other embodiments described herein, the purifying vessel 303 is designed to allow for adequate contact between the water containing halogen and the purifying media within the purifying vessel 303 so as to produce the desired degree of purification. Similar to the previous embodiments, the tablet 346 is consumed as water continuously makes contact with the tablet 346. The outer exposed sides of the tablet eventually wear down, thus allowing the indicating rod 318 to drop. Similar to the indicating rod 118, the indicating rod 318 may include a flag 344 at the top of the indicating rod 318 to alert the user that the tablet 346 has been consumed or needs replacing at which point the user may remove the cover 301 and disassemble the indicating rod 318 by simply lifting the rod 318 out of the indicating rod guide 319. Alternatively, the entire assembly, including the indicating rod guide 319 and the filter case 306, can be disassembled for placement of the tablet 346 atop the plunger 308. In one embodiment, the indicating rod guide 319 can have a bore which has a diameter substantially the same as the diameter of the tablet 346 to guide the tablet 346 through the bore so that it can be dropped accurately on its side atop the plunger 308. In another embodiment, a translucent cap similar to the cap 116, can be placed over the indicating flag 344 so as to provide an alternative means of indicating when the tablet 346 is exhausted or needs replacing.

The stem of the plunger 308 fits within and slides up and down in the bore in the neck of the plunger guide 310. However, the height of the neck of the plunger guide 310 prevents the underside of the mushroom head of the plunger 308 to completely seat against the floor of the plunger guide 310. The height of the neck preferably holds the tablet about the same height as water entering from the holes 316, so that water strikes the tablet 346 around its circumference. The water with halogen flows down the sloped side of the mushroom head of the plunger 308, then flows underneath the mushroom head and through the central holes in the plunger guide 310. Thus, the area defined within the holes 316 in the inner cylindrical wall 313 within which the tablet 346 is located is functionally similar to the dispenser 136. As in the previous first and second embodiments of FIGS. 1-8, the tablet 346 and the act of dispensing halogen atoms to water to maintain the biocidal activity of the purifying media are similar.

Referring to FIG. 12, another advantageous feature of the pitcher 300 is performed by the plunger 308. Because the filter media 314 can eventually plug with debris, a means is provided to backflow the filter media 314, which will now be described. The upper canister 302 can be disassembled from the remainder of the pitcher 300. The purifying vessel 303 can be removed from the bottom of the upper canister 302. A suitably sized hose or other such device that can push water can be attached to the rim extending on the underside of the plunger guide 310. Pressurized water can then be made to flow up and through the center holes 309 in the plunger guide 310. The water pressure on the underside of the mushroom head of the plunger 308 forces the plunger 308 upwards. The sloped sides 311 of the mushroom head of the plunger 308 seal against a sloped seat 320 surrounding the inner cylindrical wall of the filter case 306. The seat 320 is located above the holes 316 at the bottom of the inner cylindrical wall 313 so that water does not flow up through the inner cylindrical wall, but is forced through the holes 316 at the bottom of the inner cylindrical wall 313 into the area between the inner 313 and outer 306 cylindrical walls containing the filter media 314 and will then force the water to pass through the filter media 314, thus performing backwashing of the filter media 314. The water will then exit the filter case 306 through the slits 307 in the outer cylindrical wall of the filter case 306. Thus, via this operation, the filter media 314 can be backwashed and thus extend the life of the filter media 314.

Similar to the previous embodiments, the unpurified water containing halogen eluted from the tablet 346 will pass into the purifying vessel 303, where the water makes contact with a purifying media similar to the purifying media discussed above. The purifying action takes place similarly to what has been described above. The purified water will exit through the bottom screen of the purifying vessel 303 and into the pitcher 300, the body of which functions as a lower canister 304 containing the purified water. The upper canister 302 has sloped sides so that as the pitcher 300 is tipped, purified water is allowed to flow between the inner wall of the pitcher 300, and the outer wall of the upper canister 302 and through the spout 381.

While illustrative embodiments have been illustrated and described, it will be appreciated that various changes can be made therein without departing from the spirit and scope of the invention.

The embodiments of the invention in which an exclusive property or privilege is claimed are defined as follows:

1. A water purifier, comprising:
a dispenser to deliver halogen from a material to unpurified water thereby producing unpurified water with halogen;
a purifying media in the path of the unpurified water with halogen, wherein the purifying media binds the halogen, thereby maintaining the activity of the purifying media to purify the unpurified water to purified water; and
an indicator that monitors the material to indicate when the material needs replacing.

2. The water purifier of claim 1, wherein the indicator is in contact with the material.

3. The water purifier of claim 2, wherein the indicator is located within the dispenser.

4. The water purifier of claim 1, wherein the dispenser comprises a forward passage and a rear passage for the unpurified water to enter and leave the dispenser and receive the halogen thereby.

5. The water purifier of claim 1, wherein the dispenser further comprises the indicator.

6. The water purifier of claim 1, wherein the indicator includes an indicating rod that rests on the material and drops as the material is consumed.

7. The water purifier of claim 1, wherein the indicator includes a cap through which a user can view a flag that indicates the material needs replacing.

8. The water purifier of claim 1, wherein the purifying media is a heterocyclic N-halo amine, a N-halo hydantoin, a polystyrene having pendant N-halo hydantoin groups, or a crosslinked polystyrene having pendant N-halo hydantoin groups.

9. The water purifier of claim 8, wherein the purifying media is a 3% to 10% crosslinked polystyrene having pendant N-bromo hydantoin groups.

10. The water purifier of claim 1, further comprising a collection basin, the collection basin housing the dispenser, the purifying media, and the indicator.

11. The water purifier of claim 10, wherein the collection basin comprises a lower surface adapted to receive the upper surface of a lower canister.

12. The water purifier of claim 11, wherein the lower surface is adapted for receiving lower canisters of varying diameters.

13. The water purifier of claim 10, further comprising a top ring above the collection basin, wherein the top ring is adapted to receive an upper canister.

14. The water purifier of claim 13, wherein the top ring is adapted for receiving upper canisters of varying diameters.

15. The water purifier of claim 13, wherein the top ring includes locating features on the upper surface.

16. The water purifier of claim 13, wherein the top ring includes one or more concentric rings defined by one or more arcuate ribs.

17. The water purifier of claim 13, wherein the top ring slopes from the inner diameter to the outer diameter.

18. The water purifier of claim 10, further comprising a dwell chamber beneath the collection basin, wherein the dwell chamber holds the purified water before being discharged.

19. The water purifier of claim 18, wherein the dwell chamber has a series of baffles to change the direction of the flow of the purified water before being discharged.

20. The water purifier of claim 18, wherein the dwell chamber includes a filter to trap particulates before the purified water is discharged.

21. The water purifier of claim 20, wherein the dwell chamber includes a filter holder with openings and the filter height is lower than the height of the openings.

22. The water purifier of claim 18, wherein the dwell chamber comprises a prefilter compartment, a post-filter compartment, and a pre-discharge compartment.

23. The water purifier of claim 22, further comprising a dam between the post-filter compartment and the pre-discharge compartment.

24. The water purifier of claim 23, wherein the water passes from the post-filter compartment to the pre-discharge compartment by passing under the dam.

25. The water purifier of claim 10, wherein the purifying media is housed in the collection basin in a purifying vessel, the collection basin including a channel to lead unpurified water containing halogen from the dispenser to the purifying vessel.

26. The water purifier of claim 10, wherein the collection basin includes one or more barriers directing the unpurified water without halogen to the dispenser.

27. The water purifier of claim 10, wherein the collection basin includes a channel that leads the unpurified water with halogen to the purifying media.

28. The water purifier of claim 10, wherein the collection basin includes a water distributor after the dispenser and before the purifying media.

29. The water purifier of claim 28, wherein the water distributor includes a top surface with notches around the outer periphery of the top surface to allow water to pass from the top surface of the water distributor through the notches.

30. The water purifier of claim 28, wherein the water distributor includes a top surface and a first and a second ring on the underside of the top surface, wherein the second ring diameter is smaller than the first ring diameter.

31. The water purifier of claim 30, wherein the first and the second ring are not concentric with respect to each other.

32. The water purifier of claim 30, wherein the second ring has notches on the lower periphery thereof.

33. The water purifier of claim 30, wherein the water distributor includes notches around the periphery of the top surface, an outer ring on the underside of the top surface, and an inner ring on the underside of the top surface, such that water passing through the notches enters the space between the outer ring and the inner ring.

34. The water purifier of claim 10, wherein the collection basin includes a channel in which the bottom of the dispenser is located.

35. The water purifier of claim 10, wherein the collection basin includes a channel in which the material is located.

36. The water purifier of claim 1, further comprising a purifying vessel that houses the purifying media, the purifying vessel being placed in a path to receive unpurified water with halogen.

37. The water purifier of claim 36, further comprising a first and a second screen that retain the purifying media within the purifying vessel.

38. The water purifier of claim 36, further comprising a dwell chamber, wherein the dwell chamber receives the lower end of the purifying vessel.

39. The water purifier of claim 1, comprising a collection basin that houses a purifying vessel in which the purifying media is located.

40. The water purifier of claim 39, comprising a dwell chamber below the collection basin, the dwell chamber receiving the purifying vessel in a compartment therein.

41. The water purifier of claim 40, wherein the dwell chamber discharges water before the water level can rise above the bottom of the purifying vessel.

42. The water purifier of claim 1, comprising a collection basin and a seat on the underside of the collection basin.

43. The water purifier of claim 42, wherein the seat is placed between an outer rim and an inner rim that is concentric with the outer rim.

44. The water purifier of claim 1, comprising a collection basin having a purifying vessel for containing the purifying media and a cap on the upper end of the purifying vessel, wherein the cap includes perforations.

45. A water purifier, comprising:
a collection basin adapted to fit between an upper canister and a lower canister;
a dispenser housed within the collection basin;
a purifying media housed within the collection basin; and
an indicator housed within the collection basin, wherein the dispenser is adapted to receive a material that delivers halogen to water, the collection basin is adapted to deliver water with halogen to the purifying media, and the indicator is adapted to indicate when the material needs replacing.

46. A water purifier, comprising:
means for dispensing halogen to unpurified water without halogen, thereby producing unpurified water with halogen;
a purifying media placed in the path of the unpurified water with halogen, wherein the purifying media binds the halogen, thereby maintaining the activity of the purifying media to purify the unpurified water into purified water; and
means for indicating when the material needs replacing.

47. The water purifier of claim 46, wherein the water purifier is adapted to be placed between an upper canister and a lower canister.

48. The water purifier of claim 46, wherein the means for dispensing halogen includes a tablet and a holder for the tablet that allows water to contact the tablet, thus dispensing halogen from the tablet to the water.

49. The water purifier of claim 46, wherein the water purifier is contained within a pitcher.

50. The water purifier of claim 49, wherein the pitcher comprises an upper canister that fits within the inside of the pitcher, the upper canister housing the means for dispensing halogen and the means for indicating.

51. The water purifier of claim 49, wherein the means for indicating includes an indicating rod that makes contact with a material that elutes halogen.

52. The water purifier of claim 49, comprising an upper canister with a hole therein to allow water to pass from the upper canister to the purifying media.

53. The water purifier of claim 52, further comprising a filter before the purifying media.

54. The water purifier of claim 53, further comprising a plunger assembly that allows water to pass from the upper canister to the purifying media, and moves to allow back flushing of the filter.

55. The water purifier of claim 53, wherein the filter comprises a filter case having an outer cylindrical wall and an inner cylindrical wall, wherein the filter case allows water to pass from the upper canister and into a dispenser, wherein halogen is dispensed to water.

56. The water purifier of claim 46, comprising a purifying vessel to contain the purifying media.
